(19) United States
(12) Patent Application Publication
(10) Pub. No.: US 2017/0118242 A1
(43) Pub. Date: Apr. 27, 2017

(54) METHOD AND SYSTEM FOR PROTECTION AGAINST DISTRIBUTED DENIAL OF SERVICE ATTACKS

(71) Applicants: Sorin-Marian GEORGESCU, Mount Royal, Québec (CA); TELEFONAKTIEBOLAGET LM ERICSSON (PUBL), Stockholm (SE)

(72) Inventor: Sorin-Marian Georgescu, Mount Royal (CA)

(73) Assignee: TELEFONAKTIEBOLAGET LM ERICSSON (PUBL), Stockholm (SE)

(21) Appl. No.: 15/129,179

(22) PCT Filed: Mar. 27, 2014
(86) PCT No.: PCT/IB2014/060226

§ 371 Date: Sep. 26, 2016

(51) Int. Cl. H04L 29/06

(52) U.S. Cl. CPC H04L 63/1458; H04L 63/1425; H04L 2463/141

(57) ABSTRACT

A denial-of-service protection system may include a memory operable to store a behavior model and a processor communicatively coupled to the memory. The processor is capable of detecting a potential attack on the system, and receiving a first request from an endpoint. In response to receiving the first request from the endpoint, the processor may communicate an error to the endpoint. The processor may also receive a second request, from the endpoint and determine whether the second request from the endpoint deviates from the behavior model. If the second request from the endpoint deviates from the behavior model, the processor may deny traffic from the endpoint. If the second request from the endpoint does not deviate from the behavior model, then the processor may allow traffic from the endpoint.

### TECHNICAL FIELD

Particular embodiments relate generally to a denial-of-service protection system and more particularly to a method and system for protection against distributed denial-of-service attacks based on clustering of enforced error behavior.

### BACKGROUND

Distributed denial-of-service (DDoS) attacks represent a modern flavor of traditional denial-of-service attacks which have been experienced since the early days of the Internet. In distributed denial-of-service attacks, multiple attackers communicate a large volume of traffic towards a targeted system with the intention of impacting the availability of services and resources provided by the targeted system. The attackers may be spread over multiple geographic areas (e.g. countries) or be localized in one Internet domain (e.g. university campus).

DDoS attacks may target the IP layer, as well as the application layer. IP layer DDoS attacks are typically detected and blocked by nodes in the IP connectivity infrastructure (e.g. firewalls, routers, or load balancers). On the other hand, application layer DDoS require monitoring of the targeted server resources (e.g. CPU load, memory consumption, open ports, database server load, processing delay, etc.) and therefore cannot be efficiently detected by the nodes in the IP infrastructure.

More recently, “soft” variants of DDoS attacks have been seen, where the attackers perform a quasi-normal traffic pattern with significant impact on system resources usage. This is known as distributed degradation-of-service (DDgS) attacks. Such attacks have impacts on the user experience and can affect the company's reputation. DDgS attacks are very difficult to detect with current detection methods.

### SUMMARY

According to some embodiments, a denial-of-service protection system may include a memory operable to store a behavior model and a processor communicatively coupled to the memory. The processor is capable of detecting a potential attack on the system and receiving a first request from an endpoint. In response to receiving the first request from the endpoint, the processor may communicate an error to the endpoint. The processor may also receive a second request from the endpoint and determine whether the second request from the endpoint deviates from the behavior model. If the second request from the endpoint deviates from the behavior model, the processor may deny traffic from the endpoint. If the second request from the endpoint does not deviate from the behavior model, then the processor may allow traffic from the endpoint.

In some embodiments, the processor is further able to receive a first baseline request from a friendly endpoint during a baseline period. The processor may determine a type associated with the first baseline request and determine a baseline error message based at least in part upon the first baseline request. The processor may also communicate the baseline error message to the friendly endpoint and receive a second baseline request from the friendly endpoint during the baseline period. The processor is also capable of determining a response characteristic associated with the second baseline request received during the baseline period and then generating the behavior model based in part upon the response characteristic.

In some embodiments, the above functionality may be implemented in a method for protecting a system or a content server.

### BRIEF DESCRIPTION OF THE DRAWINGS

For a more complete understanding of the present disclosure and its advantages, reference is made to the following descriptions, taken in conjunction with the accompanying drawings in which:

FIG. 1 is a block diagram illustrating an embodiment of a denial-of-service environment;

FIG. 2 is a block diagram illustrating an example embodiment of a server;

FIG. 3 is a block diagram illustrating an example embodiment of a computer; and

FIGS. 4 and 5 are flowcharts illustrating example embodiments of method steps.

### DETAILED DESCRIPTION

As stated before, in a distributed denial-of-service (DDoS) attack, multiple attackers, numbering in the hundreds or thousands, perform an overall high volume of traffic towards a targeted system. Analysis of DDoS traffic showed that there is likely a high degree of correlation between traffic patterns sent by attackers, which suggests that DDoS attacks could be detected by calculating the correlation between the traffic patterns. However, there are a number of drawbacks with this approach, hence more advanced techniques need to be proposed.

As for “soft” variants of DDoS attacks, known as distributed degradation of service (DDgS) attacks, these have an impact on the user experience. Because DDgS attacks pass along mostly undetected, the user experience may remain degraded for a fairly long time. DDgS attacks are very difficult to detect with current detection methods considering that attackers adapt traffic patterns to closely mimic normal traffic, except for the fact that the attackers invoke features that require the usage of significant system resources.

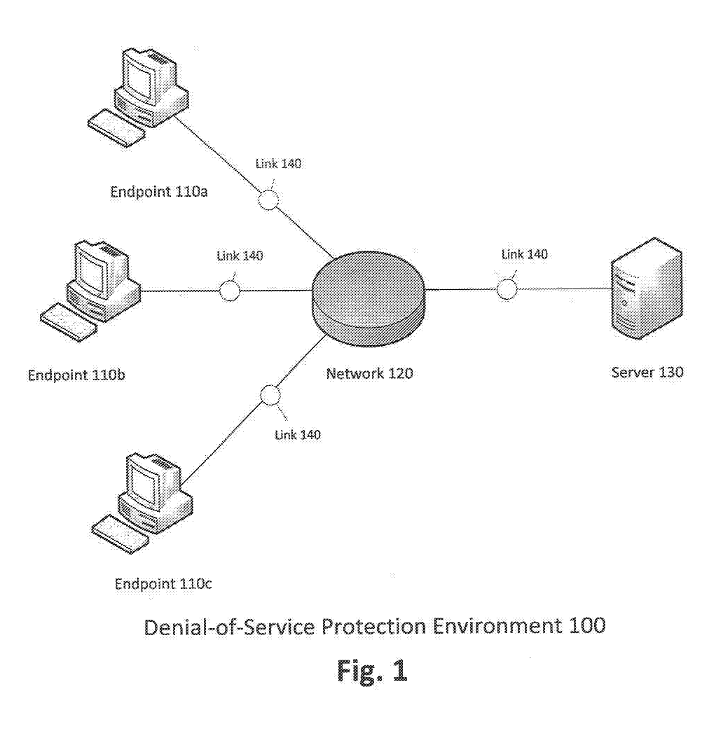

Particular embodiments may provide a solution to these and other problems. For example, in some embodiments, a system may detect a potential DDoS attack by monitoring system resources. If an attack is detected, the system may start analyzing requests from endpoints to determine whether the behavior of the endpoints deviates from a behavior model of normal (i.e. non-malicious) endpoint behavior. If the system determines that an endpoint's behavior deviates from the behavior model, the system may block all traffic from that endpoint. If the system determines that an endpoint's behavior corresponds to the behavior model, then the system may allow traffic from that endpoint. Although certain portions of this disclosure may only mention “DDoS”, “DDgS” or “a distributed attack” it should be understood that the systems and methods described in this disclosure are not limited to a single type of attack and may be used to protect a system from all attacks discussed herein. Particular embodiments are described in FIGS. 1-5 of the drawings, like numerals being used for like and corresponding parts of the various drawings.

FIG. 1 illustrates an example denial-of-service protection environment that may be associated with a denial-of-service protection system. Denial-of-service protection environment 100 may include endpoints 110, network 120, and server 130. Generally, endpoints 110 may communicate with server 130 over network 120, generating network traffic and using server resources. For example, a particular endpoint 110 may communicate a message over network 120 to server 130, the message comprising a request to use a resource or service associated with server 130. In response, server 130 may fulfill or deny the request.

Endpoints 110 each may be any device capable of providing functionality to, being operable for a particular purpose, or otherwise used by a user to access particular functionality of denial-of-service protection environment 100. Endpoints 110 may be operable to communicate with network 120, server 130, and/or any other component of denial-of-service protection environment 100. As an example, each endpoint 110 may be a laptop computer, desktop computer, terminal, kiosk, personal digital assistant (PDA), cellular phone, tablet, portable media player, smart device, smart phone, or any other device capable of electronic communication. In FIG. 1, endpoint 110a, endpoint 110b, and endpoint 110c are depicted as three distinct example endpoints 110. Although three endpoints 110 are depicted in FIG. 1, denial-of-service protection environment 100 is capable of accommodating any number of endpoints 110 as suitable for a particular purpose. In certain embodiments, certain endpoints 110 may be determined to be “friendly” endpoints 110. For example, friendly endpoints 110 may be endpoints 110 operated by trusted users (e.g., employees of an enterprise operating denial-of-service protection environment 100), endpoints 110 connected to a particular network 120, and/or endpoints 110 that may otherwise have been determined by denial-of-service protection environment 100 as not being used for a malicious attack and can be utilized for baseline testing.

Endpoints 110 may communicate a message over network 120 to server 130. This disclosure contemplates any suitable network 120. As an example and not by way of limitation, one or more portions of network 120 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 120 may include one or more networks, such as those described herein.

Endpoints 110 may communicate any suitable electronic message to server 130. In some embodiments, an enterprise may offer a variety of services to users through server 130. For example, server 130 may offer web content, database services, cloud computing services, storage services, hosting services, resource services, management services, and/or any other service to a user or endpoint 110 suitable for a particular purpose. Endpoint 110 may request access to or initiation of a particular service offered by server 130 and in response server 130 may process the request and grant or deny the request. However, malicious attackers can implement DDoS or DDgS attacks to disrupt the performance of server 130. More specifically, in addition to providing various services to users, server 130 may also be configured to detect DDoS or DDgS attacks. In certain embodiments, server 130 may do this by monitoring processing load such as average processor load, memory usage, hard disk drive usage, database load, sockets opened, and/or any other suitable metric that may indicate processing load as suitable for a particular purpose. In such embodiments, server 130 may compare processing load to a baseline processing load threshold and determine that server 130 and/or any other suitable component of denial-of-service protection environment 100 may be under attack.

According to some embodiments, once a potential attack is detected, server 130 may be configured to enter into a protection state and take steps to filter out any traffic from a potentially malicious endpoint 110 that may be a part of a DDoS or DDgS attack. For example, after detection of a potential attack, server 130 may be configured to respond to all queued requests with an error message. Server 130 may then compare responses to the error messages to a behavior model. If server 130 determines that a particular response deviates from the behavior model, server 130 may deny traffic from that particular endpoint 110. For example, server 130 may refuse all communication originating from an IP address associated with the particular endpoint 110. If server 130 determines that responses to error messages do not deviate from the behavior model, server 130 may allow traffic from that particular endpoint 110. In addition to comparing responses to a behavior module, server 130 may also be capable of generating the behavior model.

In certain embodiments, the components of denial-of-service protection environment 100 may be configured to communicate over links 140. Communication over links 140 may communicate requests, responses, and/or any other information to and/or from any suitable component of denial-of-service protection environment 100. Links 140 may connect endpoints 110 and server 130 to network 120 or to each other. This disclosure contemplates any suitable links 140. In particular embodiments, one or more links 140 include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 140 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 140, or a combination of two or more such links. Links 140 need not necessarily be the same throughout denial-of-service protection environment 100. One or more first links 140 may differ in one or more respects from one or more second links 140.

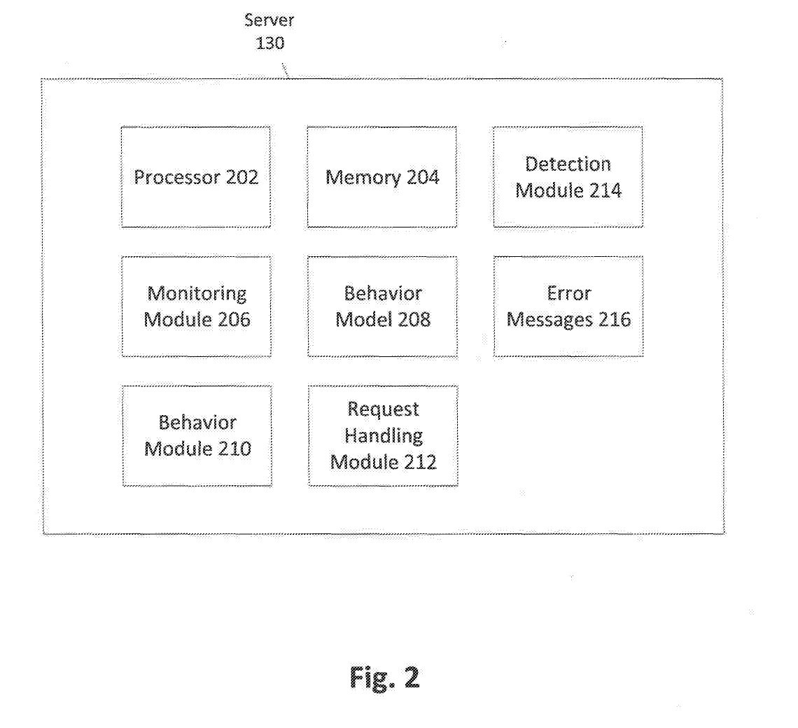

FIG. 2 is a block diagram illustrating an example embodiment of server 130 used in FIG. 1. Server 130 may include a processor 202, memory 204, monitoring module 206, behavior model 208, behavior module 210, request handling module 212, detection module 214, and error messages 216. In some embodiments, processor 202 executes instructions to provide some or all of the functionality described in this disclosure as being provided by server 130, and memory 204 stores the instructions executed by processor 202.

Processor 202 may include any suitable combination of hardware and software implemented in one or more modules to execute instructions and manipulate data to perform some or all of the described functions of server 130 by, for example, implementing functionality of the modules of server 130. In some embodiments, processor 202 may include, for example, processing circuits, one or more computers, one or more central processing units (CPUs), one or more microprocessors, one or more applications, and/or other logic.

Memory 204 is generally operable to store data or instructions, such as a computer program, software, an application including one or more of logic, rules, algorithms, code, tables, etc. and/or other instructions capable of being executed by a processor. Examples of memory 204 include computer memory (for example, Random Access Memory (RAM) or Read Only Memory (ROM)), mass storage media (for example, a hard disk), removable storage media (for example, a Compact Disk (CD) or a Digital Video Disk (DVD)), and/or or any other volatile or non-volatile, non-transitory computer-readable and/or computer-executable memory devices that store information.

Server 130 may monitor denial-of-service protection environment 100 to detect potential malicious attacks against the example system. In certain embodiments, server 130 may use monitoring module 206 to monitor various characteristics of denial-of-service protection environment 100. For example, monitoring module 206 may monitor one or more characteristic associated with processing load of server 130 such as average processor load, memory usage, hard disk drive usage, processing time, database load, number of sockets opened, and/or any other characteristic suitable for monitoring any component of denial-of-service protection environment 100. Monitoring module 206 may be any combination of software, hardware, and/or firmware capable of monitoring characteristics associated with denial-of-service protection environment 100.

Based on monitored characteristics, server 130 may detect potential malicious attacks against the example system. According to some embodiments, server 130 may use detection module 214 to detect potential malicious attacks against denial-of-service environment 100. Detection module 214 may access information associated with monitored characteristics obtained by monitoring module 206 and determine whether one or more characteristics are indicative of a potential malicious attack against server 130. Detection module 214 may be any combination of software, hardware, and/or firmware capable of accessing characteristics associated with denial-of-service protection environment 100 and detecting a potential attack against the example system. Detection module 214 is capable of discriminating normal traffic flow from distributed attacks against the system. As an example, detection module 214 may determine that at least one characteristic (e.g., processor load, memory usage, processing time) is above a particular threshold indicating a potential malicious attack. If detection module 214 detects that a particular threshold is exceeded, it may instruct server 130 to enter into a protection state.

When entering into a protection state, server 130 may take steps to determine which endpoints 110 are potentially a part of a distributed attack on the system as opposed to endpoints 110 operating normally. More specifically, in the protection state, server 130 may respond to any queued requests with error messages. In certain embodiments, server 130 may use request handling module 212 to process various requests received from endpoints 110. In a protection state, request handling module 212 may respond to requests received from endpoints 110 with a particular one of error messages 216. Error messages 216 may be any message indicative of a potential error. Some examples of error messages 216 are “request timed out,” “URL not found,” “service unavailable,” “redirect,” “unauthorized,” and “request URI too long.” In certain embodiments, error messages 216 may be error messages associated with hypertext transfer protocol (“HTTP”) errors. Error messages 216 may be stored in memory 204 or they may be references to error messages defined by industry protocols, standards, and/or specifications (e.g., HTTP).

Request handling module 212 is capable of selecting a particular error message 216 in response to a request received from an endpoint 110. Request handling module 212 may select a particular error message 216 based on the type of request received from endpoint 110. Request handling module 212 may also specify a response delay instruction for endpoint 110 to respond the particular error message 216. For example, request handling module 212 may do this by specifying a period of time in the HTTP “Retry-After” header. This period of time may be zero or null or it may be any value greater than zero seconds up to a maximum value allowed by the particular communication protocol utilized by the example system. In certain embodiments, request handling module 212 may respond with a particular sequence of error messages 216 to requests received from a particular endpoint 110 or it may use a randomized sequence of error messages 216 in response to requests received from a particular endpoint 110. Request handling module 212 may also be capable of blocking messages from particular endpoints 110 that have been deemed to be a part of a distributed attack.

Based on the behavior of a particular endpoint 110 in response to one or more error messages 216 received from server 130, server 130 can determine whether endpoint 110 is a part of a distributed attack. Server 130 may make this determination based on behavior model 208. Generally, behavior model 208 is any collection of clustered data that is indicative of normal or expected behavior from endpoints 110. Server 130 can compare the behavior of an endpoint 110 against behavior model 208 to discriminate legal clients/users (e.g., those endpoints 110 exhibiting normal or expected behavior) from DDoS attackers. In certain embodiments, behavior model 208 may be stored in memory 204. Behavior model 208 may be stored in one or more text files, tables in a relational database, or any other suitable data structure capable of storing information.

Server 130 may generate behavior model 208 as well as compare behavior of endpoints 110 to behavior model 208. In certain embodiments, server 130 may initiate the generation of and comparisons to behavior model 208 using behavior module 210. Behavior module 210 may be any combination of software, hardware, and/or firmware capable of generating and comparing behavior model 208. Generally, behavior module 210 may generate behavior model 208 during a baseline testing period by quantifying, in clusters, endpoint 110 behavior when receiving error messages 216. The present disclosure contemplates any suitable clustering algorithm used by behavior module 210 to accomplish this task. In certain embodiments, the clustering algorithm used by behavior module 210 is based at least in part upon adaptive resonance theory. According to some embodiments, behavior module 210 may utilize artificial neural networks to build behavior model 208. The generation of behavior model 208 is based on the behavior of “friendly” endpoints 110 (i.e., endpoints 110 confirmed as not being a part of a distributed attack) during a baseline or test period. Friendly endpoints 110 may be endpoints 110 that are connected to a network 120 local to server 130 and/or are operated by trusted users (e.g., employees of the enterprise).

More specifically, behavior module 210 is capable of associating incoming requests from endpoints 110 to one of a plurality of request type categories. These categories may be based on the resources used for the execution of the request in conditions of normal traffic. Behavior module 210 is also capable of instructing request handling module 212 to determine a set of error messages 216 that may be associated with a request type of a particular request received from a friendly endpoint 110. After a set of error messages 216 is determined, a particular one of the error messages 216 may be randomly selected to respond to the request received from a friendly endpoint 110. Additionally, a response delay period may be determined to associate with the particular error message 216. This response delay period may be zero or it may be any time period greater than zero seconds up to a maximum allowable delay period associated with the error message 216. In certain embodiments, if the particular error message 216 is the first error message 216 of the determined set of error messages 216 sent to friendly endpoint 110, then the delay period may be zero or null. According to some embodiments, a delay period may be selected from a set of predefined delay periods associated with the determined set of error messages 216. In other embodiments, a delay period may be selected from a default set of predefined delay periods. The delay period may be selected randomly or it may be selected according to a predefined order.

Additionally, behavior module 210 is capable of instructing request handling module 212 to communicate selected error messages 216 to friendly endpoints 110. In certain embodiments, error messages 216 may be communicated in response to a request received without effectively executing the request. Behavior module 210 may also determine response characteristics (e.g., elapsed time period until receiving a subsequent request) associated with any subsequent requests received from endpoint 110. Using information associated with a request, behavior module 210 may generate an input vector for a clustering algorithm to use based at least in part upon response characteristics of the received request. For example, the input vector may include a type or category associated with the request, error message 216 communicated to endpoint 110, the delay period associated with the error message 216, the elapsed time after which endpoint 110 had sent the new request, and/or any other suitable information that may be used in a clustering algorithm. Behavior module 210 may also initiate the application of a chosen clustering algorithm to find the closest cluster to the generated input vector. In applying the clustering algorithm, it may be determined that, based on the input vector, a new cluster should be created. In some embodiments, clusters of behavior model 208 may be based on the type or category of a request. Based on the input vector, the appropriate cluster position and size are adjusted, “learning” from the information presented in the input vector. In certain embodiments, the clustering algorithm may be instructions stored in memory 204 executed by processor 202. In addition to initially building behavior model 208, behavior module 210 is capable of adjusting or updating behavior model 208 as appropriate. In some embodiments, behavior module 210 may determine that behavior model 208 was generated under unsatisfactory conditions (e.g., a friendly endpoint 110 was actually a malicious endpoint 110) and in response may roll back behavior model 208 to a prior behavior model 208 or otherwise adjust behavior model 208 to compensate for the unsatisfactory conditions.

To gain a better understanding of the capabilities of server 130, the operation of server 130 will now be discussed. The generation of behavior model 208 will be discussed first and the detection of and protection from a distributed attack will be discussed second. Server 130 may build behavior model 208 during a baseline period when it has been determined that server 130 is not experiencing a distributed attack. During this baseline period, server 130 may determine system characteristics. For example, server 130 may use monitoring module 206 to determine memory usage, processor load, processing time, hard disk drive usage, database load, average processor load, sockets opened, or any other system characteristics suitable for a particular purpose.

Server 130 may receive a first baseline request from a friendly endpoint 110 during the baseline period. For example, a friendly endpoint 110 may communicate this request to server 130 via link 140 over network 120. In response, server 130 may determine a type associated with the first baseline request. In certain embodiments, server 130 may use behavior module 210 to determine a type associate with the first baseline request. Server 130 may then determine a baseline error message 216 based at least in part upon the first baseline request. For example, baseline error message 216 may be based on the type associated with the first baseline request. Server 130 may use behavior module 210 to randomly select a first error message 216 from a plurality of error messages 216 that may be associated with the first baseline request. If the baseline request is a baseline request subsequent to prior baseline requests, then behavior module 210 may randomly select an error message 216 from the set of error messages 216 that has not been previously communicated to friendly endpoint 110 during the baseline period. In certain embodiments, behavior module 210 may select from a set of error messages 216 that are associated with the request type of the first baseline message. Behavior module 210 may also determine a delay period to associate with the selected error message 216. In certain embodiments, behavior module 210 may randomly select a delay period from a set of delay periods associated with the request type. According to some embodiments, if the request is a request subsequent to prior requests during the baseline period, behavior module 210 may randomly select a delay period that has not previously been used for friendly endpoint 110 during the baseline period. In at least some embodiments, behavior module 210 may not specify a delay period in response to a first baseline request received from friendly endpoint 110.

After determining the appropriate baseline error message 216, server 130 may communicate the baseline error message 216 to the particular friendly endpoint 110 during the baseline period. For example, behavior module 210 may instruct request handling module 212 to communicate a particular error message 216 to the friendly endpoint 110 via link 140 over network 120. In response to error message 216, server 130 may receive a second baseline request from the friendly endpoint 110 during the baseline period.

After receiving this baseline request, server 130 may determine response characteristics associated with the second baseline request. For example, server 130 may use behavior module 210 to determine response characteristics associated with the baseline request such as the elapsed time period until the subsequent request was received. Based on the response characteristics, server 130 may generate behavior model 208. For example, behavior module 210 may generate an input vector for a clustering algorithm based at least in part upon the second baseline request received during the baseline period. Then behavior module 210 may apply the clustering algorithm to the input vector. In certain embodiments, behavior module 210 may determine that a pre-existing behavior model 208 may be used and may update the pre-existing behavior model 208 based on determined information. The above steps may be repeated for a particular friendly endpoint 110 during the baseline period until the friendly endpoint 110 has been challenged with all combinations of error messages 216 and delay periods for those error messages 216. The previous steps may also be repeated for each friendly endpoint 110 or for a subset of all friendly endpoints 110 during the baseline period.

Once behavior model 208 is generated, server 130 may take steps to detect and protect the example system from a potential distributed attack. Server 130 may detect a potential attack on the system by monitoring system characteristics. For example, detection module 214 may access information obtained by monitoring module 206 regarding system characteristics. If the system characteristics are above an acceptable threshold for a particular system characteristic, detection module 214 may determine that the system is under a possible attack and take steps to protect the example system. In certain embodiments, acceptable thresholds for system characteristics may be based on system characteristics monitored during the baseline period. In response to detecting a potential attack, server 130 begins to communicate error messages 216 in response to received requests from endpoints 110. For example, server 130 may receive a first request from endpoint 110. The first request may be communicated by endpoint 110 via link 140 over network 120 to server 130.

In response to receiving the first request, server 130 may communicate error message 216 to endpoint 110. For example, server 130 may use behavior module 210, request handling module 212, and/or any other suitable component of server 130 to determine a particular error message 216. In certain embodiments, server 130 may determine a particular error message 216 based on the request type associated with the received request. According to some embodiments, there may be a set of error messages 216 associated with a particular request type. Server 130 may select one of the set of error messages 216 to communicate to endpoint 110. The selection of error message 216 may also be based on prior error messages 216 communicated to the endpoint 110 during the protected state of the example system. For example, server 130 may select one of the set of error messages 216 associated with the request type that has not previously been sent to endpoint 110 during the protected state of the example system. In certain embodiments, request handling module 212 may respond with a particular sequence of error messages 216 to requests received from a particular endpoint 110 or it may use a randomized sequence of error messages 216 in response to requests received from a particular endpoint 110. Server 130 may also determine a response delay period to associate with the selected error message 216. For example, in certain embodiments, server 130 may use request handling module 212 to select an appropriate delay period to associate with error message 216. According to some embodiments, request handling module 212 may specify a delay period in a HTTP retry-after header. The delay period may be selected randomly or it may be selected based on prior delay periods chosen for the particular endpoint 110. In some embodiments, for the first error message 216 communicated to a particular endpoint 110 during the protected state, a maximum allowable value for a delay period for the particular message 216 may be selected. According to some embodiments, the maximum value of a delay period may correspond to the maximum value of a delay period used for a particular error message 216 in building behavior model 208. Server 130 may communicate the error message 216, in some embodiments, without effectively executing the received request.

In response to the communicated error message 216, server 130 may receive a second request from endpoint 110. Server 130 may determine whether the received request deviates from behavior model 208. More specifically, server 130 may use behavior module 210 to compare response characteristics of the second request to behavior model 208. If the response characteristics of the second request do not conform to response characteristics expected from endpoint 110 based at least in part upon behavior model 208, then endpoint 110 is deviating from behavior model 208. For example, behavior module 210 may determine that the response time for the second request from endpoint 110 was shorter than the response time associated with the particular error message 216, with the particular associated delay period found in behavior model 208.

If server 130 determines that the second request from the endpoint 110 deviates from behavior model 208, then server 130 may immediately block all traffic from that endpoint 110. This particular endpoint 110 may be a part of a distributed attack. If server 130 determines that the second request from the endpoint 110 does not deviate from behavior model 208, then server 130 may allow traffic from that endpoint 110. In certain embodiments, server 130 may communicate another error message 216 to the endpoint 110 before allowing traffic. For example, server 130 may communicate another one of the set of error messages 216 associated with the type of request received from endpoint 110 and/or server 130 may choose a different delay period for a particular error message 216 communicated to endpoint 110. In certain embodiments, server 130 may challenge endpoint 110 with every error message 216 and response delay period combination, for the particular type associated with the received request, that is included in behavior model 208. Server 130 may repeat the above process for every endpoint 110 that communicates a request to server 130 during the protected state.

Some embodiments of the disclosure may provide one or more technical advantages. As an example, some embodiments provide a sensitive method for discriminating between the behavior of legal clients/users and malicious attackers due to the use of a learning behavior model. Another technical advantage for some embodiments is that it reduces the impact on performance while protecting the system from a denial of service attack due to the use of data clustering and the small number of input parameters used for input vectors. By using a small number of input parameters, the efficiency of clustering algorithms is optimized, thus conserving system resources and time. Another advantage for some embodiments of this disclosure is that it minimizes the non-availability of services provided by servers by aggressively challenging clients/users to delay their requests and afterwards gradually validating legal clients as they respond to error messages. In some embodiments, IP addresses of attackers are efficiently identified which can then be used to assist law enforcement agencies to prevent larger scale attacks. Proactive support of the security community in the fight against security attacks can help improve an enterprise's ability to handle security matters.

Some embodiments may benefit from some, none, or all of these advantages. Other technical advantages may be readily ascertained by one of ordinary skill in the art.

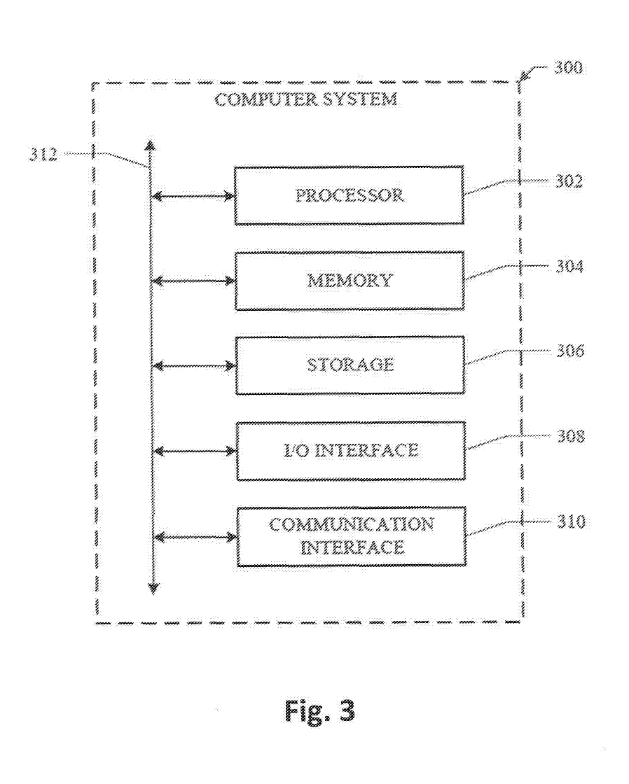

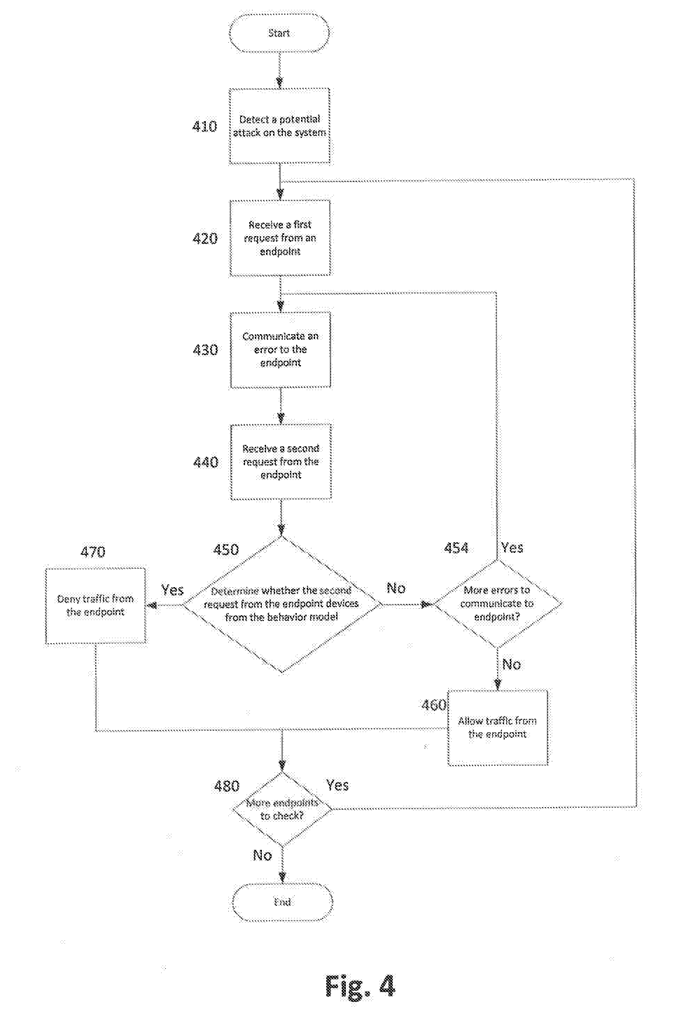

FIG. 3 is a block diagram illustrating an example embodiment of a computer. Computer system 300 may, for example, describe endpoint 110, server 130, and/or any component of denial-of-service protection environment 100 as suitable for a particular purpose. In particular embodiments, one or more computer systems 300 perform one or more steps of one or more methods described or illustrated herein. For example, computer system 300 may implement some or all steps of the methods depicted in FIGS. 4 and/or 5. In particular embodiments, one or more computer systems 300 provide functionality described or illustrated herein. In particular embodiments, software running on one or more computer systems 300 performs one or more steps of one or more methods described or illustrated herein or provides functionality described or illustrated herein. Particular embodiments include one or more portions of one or more computer systems 300. Herein, reference to a computer system may encompass a computing device, and vice versa, where appropriate. Moreover, reference to a computer system may encompass one or more computer systems, where appropriate.

This disclosure contemplates any suitable number of computer systems 300. This disclosure contemplates computer system 300 taking any suitable physical form. As example and not by way of limitation, computer system 300 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 300 may include one or more computer systems 300; be unitary or distributed; span multiple locations; span multiple machines; span multiple data centers; or reside in a cloud, which may include one or more cloud components in one or more networks. Where appropriate, one or more computer systems 300 may perform without substantial spatial or temporal limitation one or more steps of one or more methods described or illustrated herein. As an example and not by way of limitation, one or more computer systems 300 may perform in real time or in batch mode one or more steps of one or more methods described or illustrated herein. One or more computer systems 300 may perform at different times or at different locations one or more steps of one or more methods described or illustrated herein, where appropriate.

In particular embodiments, computer system 300 includes a processor 302, memory 304, storage 306, an input/output (I/O) interface 308, a communication interface 310, and a bus 312. Although this disclosure describes and illustrates a particular computer system having a particular number of particular components in a particular arrangement, this disclosure contemplates any suitable computer system having any suitable number of any suitable components in any suitable arrangement.

In particular embodiments, processor 302 includes hardware for executing instructions, such as those making up a computer program. As an example and not by way of limitation, to execute instructions, processor 302 may retrieve (or fetch) the instructions from an internal register, an internal cache, memory 304, or storage 306; decode and execute them; and then write one or more results to an internal register, an internal cache, memory 304, or storage 306. In particular embodiments, processor 302 may include one or more internal caches for data, instructions, or addresses. This disclosure contemplates processor 302 including any suitable number of any suitable internal caches, where appropriate. As an example and not by way of limitation, processor 302 may include one or more instruction caches, one or more data caches, and one or more translation lookaside buffers (TLBs). Instructions in the instruction caches may be copies of instructions in memory 304 or storage 306, and the instruction caches may speed up retrieval of those instructions by processor 302. Data in the data caches may be copies of data in memory 304 or storage 306 for instructions executing at processor 302 to operate on; the results of previous instructions executed at processor 302 for access by subsequent instructions executing at processor 302 or for writing to memory 304 or storage 306; or other suitable data. The data caches may speed up read or write operations by processor 302. The TLBs may speed up virtual-address translation for processor 302. In particular embodiments, processor 302 may include one or more internal registers for data, instructions, or addresses. This disclosure contemplates processor 302 including any suitable number of any suitable internal registers, where appropriate. Where appropriate, processor 302 may include one or more arithmetic logic units (ALUs); be a multi-core processor; or include one or more processors 302. Although this disclosure describes and illustrates a particular processor, this disclosure contemplates any suitable processor or processing circuit.

In particular embodiments, memory 304 includes main memory for storing instructions for processor 302 to execute or data for processor 302 to operate on. As an example and not by way of limitation, computer system 300 may load instructions from storage 306 or another source (such as, for example, another computer system 300) to memory 304. Processor 302 may then load the instructions from memory 304 to an internal register or internal cache. To execute the instructions, processor 302 may retrieve the instructions from the internal register or internal cache and decode them. During or after execution of the instructions, processor 302 may write one or more results (which may be intermediate or final results) to the internal register or internal cache. Processor 302 may then write one or more of those results to memory 304. In particular embodiments, processor 302 executes only instructions in one or more internal registers or internal caches or in memory 304 (as opposed to storage 306 or elsewhere) and operates only on data in one or more internal registers or internal caches or in memory 304 (as opposed to storage 306 or elsewhere). One or more memory buses (which may each include an address bus and a data bus) may couple processor 302 to memory 304. Bus 312 may include one or more memory buses, as described below. In particular embodiments, one or more memory management units (MMUs) reside between processor 302 and memory 304 and facilitate accesses to memory 304 requested by processor 302. In particular embodiments, memory 304 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 304 may include one or more memories 304, where appropriate. Although this disclosure describes and illustrates particular memory, this disclosure contemplates any suitable memory.

In particular embodiments, storage 306 includes mass storage for data or instructions. As an example and not by way of limitation, storage 306 may include a hard disk drive (HDD), a floppy disk drive, flash memory, an optical disc, a magneto-optical disc, magnetic tape, or a Universal Serial Bus (USB) drive or a combination of two or more of these. Storage 306 may include removable or non-removable (or fixed) media, where appropriate. Storage 306 may be internal or external to computer system 300, where appropriate. In particular embodiments, storage 306 is non-volatile, solid-state memory. In particular embodiments, storage 306 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 306 taking any suitable physical form. Storage 306 may include one or more storage control units facilitating communication between processor 302 and storage 306, where appropriate. Where appropriate, storage 306 may include one or more storages 306. Although this disclosure describes and illustrates particular storage, this disclosure contemplates any suitable storage.

In particular embodiments, I/O interface 308 includes hardware, software, or both, providing one or more interfaces for communication between computer system 300 and one or more I/O devices. Computer system 300 may include one or more of these I/O devices, where appropriate. One or more of these I/O devices may enable communication between a person and computer system 300. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 308 for them. Where appropriate, I/O interface 308 may include one or more device or software drivers enabling processor 302 to drive one or more of these I/O devices. I/O interface 308 may include one or more I/O interfaces 308, where appropriate. Although this disclosure describes and illustrates a particular I/O interface, this disclosure contemplates any suitable I/O interface.

In particular embodiments, communication interface 310 includes hardware, software, or both providing one or more interfaces for communication (such as, for example, packet-based communication) between computer system 300 and one or more other computer systems 300 or one or more networks. As an example and not by way of limitation, communication interface 310 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 310 for it. As an example and not by way of limitation, computer system 300 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 300 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 300 may include any suitable communication interface 310 for any of these networks, where appropriate. Communication interface 310 may include one or more communication interfaces 310, where appropriate. Although this disclosure describes and illustrates a particular communication interface, this disclosure contemplates any suitable communication interface.

In particular embodiments, bus 312 includes hardware, software, or both coupling components of computer system 300 to each other. As an example and not by way of limitation, bus 312 may include an Accelerated Graphics Port (AGP) or other graphics bus, an Enhanced Industry Standard Architecture (EISA) bus, a front-side bus (FSB), a HYPERTRANSPORT (HI) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 312 may include one or more buses 312, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

FIG. 4 illustrates an example of a mechanism for protecting a system from a DDoS or DDgS attack. In certain embodiments, the example method of FIG. 4 may be implemented by the systems described in FIGS. 1, 2, and/or 3. At step 410, server 130 may detect a potential attack on the system by monitoring system characteristics. For example, detection module 214 may access information obtained by monitoring module 206 regarding system characteristics. If the system characteristics are above an acceptable threshold for a particular system characteristic, detection module 214 may determine that the system is under a possible attack and take steps to protect the example system. In certain embodiments, acceptable thresholds for system characteristics may be based on system characteristics monitored during the baseline period. In response to detecting a potential attack, server 130 begins to communicate error messages 216 in response to received requests from endpoints 110. For example, at step 420, server 130 may receive a first request from endpoint 110. The first request may be communicated by endpoint 110 via link 140 over network 120 to server 130.

At step 430, in response to receiving the first request, server 130 may communicate error message 216 to endpoint 110. For example, server 130 may use behavior module 210, request handling module 212, and/or any other suitable component of server 130 to determine a particular error message 216. In certain embodiments, server 130 may determine a particular error message 216 based on the request type associated with the received request. According to some embodiments, there may be a set of error messages 216 associated with a particular request type. Server 130 may select one of the set of error messages 216 to communicate to endpoint 110. The selection of error message 216 may also be based on prior error messages 216 communicated to the endpoint 110 during the protected state of the example system. For example, server 130 may select one of the set of error messages 216 associated with the request type that has not previously been sent to endpoint 110 during the protected state of the example system. In certain embodiments, request handling module 212 may respond with a particular sequence of error messages 216 to requests received from a particular endpoint 110 or it may use a randomized sequence of error messages 216 in response to requests received from a particular endpoint 110. Server 130 may also determine a response delay period to associate with the selected error message 216. For example, in certain embodiments, server 130 may use request handling module 212 to select an appropriate delay period to associate with error message 216. According to some embodiments, request handling module 212 may specify a delay period in a HTTP retry-after header. The delay period may be selected randomly or it may be selected based on prior delay periods chosen for the particular endpoint 110. In some embodiments, for the first error message 216 communicated to a particular endpoint 110 during the protected state, a maximum allowable value for a delay period for the particular message 216 may be selected. According to some embodiments, the maximum value of a delay period may correspond to the maximum value of a delay period used for a particular error message 216 in building behavior model 208. Server 130 may communicate the error message 216, in some embodiments, without effectively executing the received request.

In response to the communicated error message 216, at step 440, server 130 may receive a second request from endpoint 110. At step 450, server 130 may determine whether the received request deviates from behavior model 208. More specifically, server 130 may use behavior module 210 to compare response characteristics of the second request to behavior model 208. If the response characteristics of the second request do not conform to response characteristics expected from endpoint 110 based at least in part upon behavior model 208, then endpoint 110 is deviating from behavior model 208 and the example method may proceed to step 470. For example, behavior module 210 may determine that the response time for the second request from endpoint 110 was shorter than the response time associated with the particular error message 216, with the particular associated delay period found in behavior model 208. Otherwise, the example method may proceed to step 454.

At step 470, server 130 may immediately block all traffic from the endpoint 110. This particular endpoint 110 may be a part of a distributed attack. At step 454, server 130 may determine that at least one more error message 216 should be communicated to endpoint 110 before allowing traffic. For example, server 130 may communicate another one of the set of error messages 216 associated with the type of request received from endpoint 110 and/or server 130 may choose a different delay period for a particular error message 216 communicated to endpoint 110. In certain embodiments, server 130 may challenge endpoint 110 with every error message 216 and response delay period combination, for the particular type associated with the received request, that is included in behavior model 208. If server 130 determines another error message 216 should be communicated to endpoint 110, the example may proceed back to step 430. Otherwise, the example method should proceed to step 460. At step 460, server 130 may allow traffic from endpoint 110. Server 130 may repeat the above process for every endpoint 110 that communicates a request to server 130 during the protected state, thus, at step 480, server 130 determines whether there are more endpoints to check. If there are more endpoints to check, then the example method may proceed to step 420. Otherwise, the example method may end.

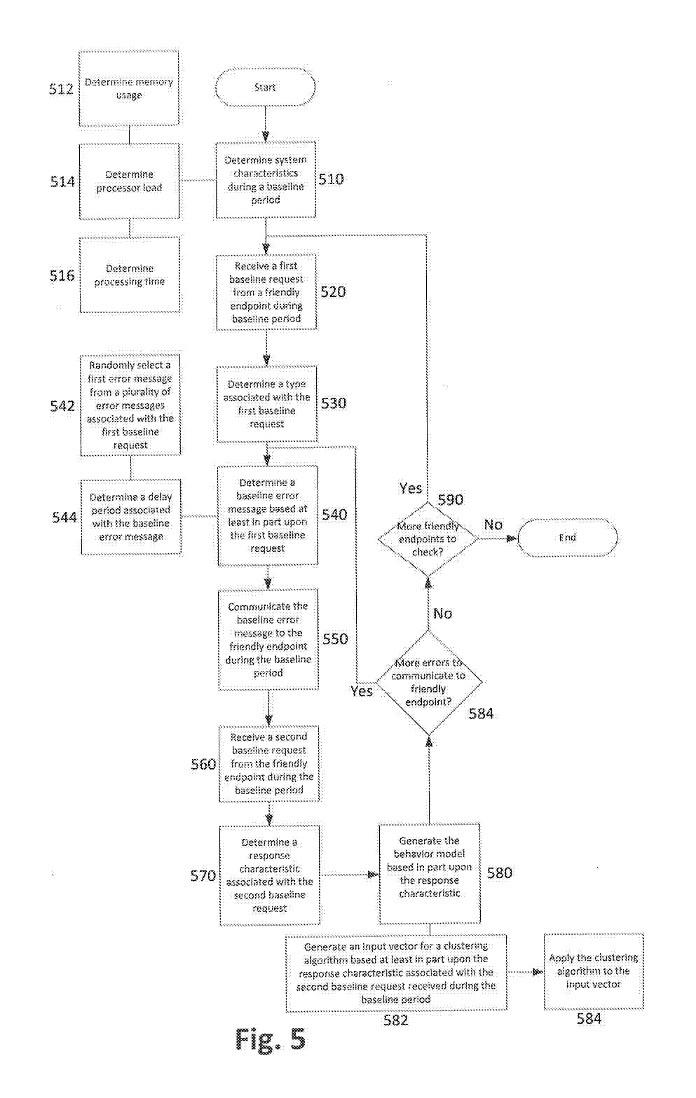

FIG. 5 illustrates an example of a mechanism for generating a behavior model. In certain embodiments, the example method of FIG. 5 may be implemented by the systems described in FIGS. 1, 2, and/or 3. Server 130 may build behavior model 208 during a baseline period when it has been determined that server 130 is not experiencing a distributed attack. At step 510, during this baseline period, server 130 may determine system characteristics. For example, server 130 may use monitoring module 206 to determine memory usage (at step 512), processor load (at step 514), or processing time (at step 516).

At step 520, server 130 may receive a first baseline request from a friendly endpoint 110 during the baseline period. For example, a friendly endpoint 110 may communicate this request to server 130 via link 140 over network 120. In response, server 130, at step 530, may determine a type associated with the first baseline request. In certain embodiments, server 130 may use behavior module 210 to determine a type associate with the first baseline request.

At step 540, server 130 may then determine a baseline error message 216 based at least in part upon the first baseline request. For example, baseline error message 216 may be based on the type associated with the first baseline request. Server 130, at step 542, may use behavior module 210 to randomly select a first error message 216 from a plurality of error messages 216 that may be associated with the first baseline request. If the baseline request is a baseline request subsequent to prior baseline requests, then behavior module 210 may randomly select an error message 216 from the set of error messages 216 that has not been previously communicated to friendly endpoint 110 during the baseline period. In certain embodiments, behavior module 210 may select from a set of error messages 216 that are associated with the request type of the first baseline message. At step 544, behavior module 210 may also determine a delay period to associate with the selected error message 216. In certain embodiments, behavior module 210 may randomly select a delay period from a set of delay periods associated with the request type. According to some embodiments, if the request is a request subsequent to prior requests during the baseline period, behavior module 210 may randomly select a delay period that has not previously been used for friendly endpoint 110 during the baseline period. In at least some embodiments, behavior module 210 may not specify a delay period in response to a first baseline request received from friendly endpoint 110.

After determining the appropriate baseline error message 216, at step 550, server 130 may communicate the baseline error message 216 to the particular friendly endpoint 110 during the baseline period. For example, behavior module 210 may instruct request handling module 212 to communicate a particular error message 216 to the friendly endpoint 110 via link 140 over network 120. In response to error message 216, server 130, at step 560, may receive a second baseline request from the friendly endpoint 110 during the baseline period.

At step 570, after receiving this baseline request, server 130 may determine response characteristics associated with the second baseline request. For example, server 130 may use behavior module 210 to determine response characteristics associated with the baseline request such as the elapsed time period until the subsequent request was received.

At step 580, based at least on the response characteristics, server 130 may generate behavior model 208. For example, behavior module 210 may generate an input vector for a clustering algorithm based at least in part upon the second baseline request received during the baseline period. Then behavior module 210 may apply the clustering algorithm to the input vector. In certain embodiments, behavior module 210 may determine that a pre-existing behavior model 208 may be used and may update behavior model 208 based on determined information. At step 584, server 130 may determine whether more errors should be communicated to friendly endpoint 110. For example, the above steps may be repeated for a particular friendly endpoint 110 during the baseline period until the friendly endpoint 110 has been challenged with all combinations of error messages 216 and delay periods for those error messages 216. If it is determined that more error messages 216 should be communicated to the friendly endpoint 110, the example method may return to step 540. Otherwise, the method may proceed to step 590. If there are more friendly endpoints for server 130 to check, then the example method may proceed to 520. For example, the previous steps may be repeated for each friendly endpoint 110 or for a subset of all friendly endpoints 110 during the baseline period. Otherwise, the example method may end.

Modifications, additions, or omissions may be made to the systems and apparatuses disclosed herein without departing from the scope of the invention. The components of the systems and apparatuses may be integrated or separated. Moreover, the operations of the systems and apparatuses may be performed by more, fewer, or other components. Additionally, operations of the systems and apparatuses may be performed using any suitable logic comprising software, hardware, and/or other logic. As used in this document, “each” refers to each member of a set or each member of a subset of a set.

Modifications, additions, or omissions may be made to the methods disclosed herein without departing from the scope of the invention. The methods may include more, fewer, or other steps. Additionally, steps may be performed in any suitable order.

Although this disclosure has been described in terms of certain embodiments, alterations and permutations of the embodiments will be apparent to those skilled in the art. Accordingly, the above description of the embodiments does not constrain this disclosure. Other changes, substitutions, and alterations are possible without departing from the spirit and scope of this disclosure, as defined by the following claims.

1-9. (canceled)

10. A method for protecting a system from a denial-of-service attack comprising:
storing a behavior model;
detecting a potential attack on the system;
receiving a first request from an endpoint;
in response to receiving the first request from the endpoint, communicating an error to the endpoint;
receiving a second request from the endpoint;
determining whether the second request from the endpoint deviates from the behavior model;
if the second request from the endpoint deviates from the behavior model, denying traffic from the endpoint; and
if the second request from the endpoint does not deviate from the behavior model, allowing traffic from the endpoint.

11. The method of claim 10, further comprising:
receiving a first baseline request from a friendly endpoint during a baseline period;
determining a baseline error message based at least in part upon the first baseline request;
communicating the baseline error message to the friendly endpoint;
receiving a second baseline request from the friendly endpoint during the baseline period;
determining a response characteristic associated with the second baseline request received during the baseline period; and
generating the behavior model based in part upon the response characteristic.

12. The method of claim 11, wherein determining the baseline error comprises randomly selecting a first error message from a plurality of error messages associated with the first baseline request.

13. The method of claim 11, wherein determining the baseline error comprises determining a delay period associated with the baseline error message.

14. The method of claim 11, wherein determining the response characteristic associated with the second baseline request comprises determining a time period of delay before receiving the second baseline request.

15. The method of claim 11, wherein generating the behavior model comprises:
generating an input vector for a clustering algorithm based at least in part upon the response characteristic associated with the second baseline request received during the baseline period; and
applying the clustering algorithm to the input vector.

16. The method of claim 15, wherein the clustering algorithm is based at least in part upon adaptive resonance theory.

17. The method of claim 11, wherein determining system characteristics during the baseline period comprises:
determining processor load during the baseline period;
determining memory usage during the baseline period; and
determining processing time during the baseline period.

18. The method of claim 10, wherein denying traffic from the endpoint comprises denying traffic from an IP address associated with the endpoint.

19. A server comprising:
a memory; and
a processor communicatively coupled to the memory, the processor operable to:
detect a potential attack on the system;
receive a first request from an endpoint;
in response to receiving the first request from the endpoint, communicate an error to the endpoint;
receive a second request from the endpoint;
determine whether the second request from the endpoint deviates from a behavior model;
if the second request from the endpoint deviates from the behavior model, deny traffic from the endpoint; and
if the second request from the endpoint does not deviate from the behavior model, allow traffic from the endpoint.

20. The server of claim 19, wherein the processor is further operable to:
receive a first baseline request from a friendly endpoint during a baseline period;
determine a baseline error message based at least in part upon the first baseline request;
communicate the baseline error message to the friendly endpoint;
receive a second baseline request from the friendly endpoint during the baseline period;
determine a response characteristic associated with the second baseline request received during the baseline period; and
generate the behavior model based in part upon the response characteristic.

21. The server of claim 20, wherein the processor operable to determine the baseline error message comprises the processor operable to randomly select a first error message from a plurality of error messages associated with the first baseline request.

22. The server of claim 20, wherein the processor operable to determine the baseline error message comprises the processor operable to determine a delay period associated with the baseline error message.

23. The server of claim 20, wherein the processor operable to determine the response characteristic associated with the second baseline request comprises the processor operable to determine a time period of delay before receiving the second baseline request.

24. The server of claim 20, wherein the processor operable to generate the behavior model comprises the processor operable to:
generate an input vector for a clustering algorithm based at least in part upon the response characteristic associated with the second baseline request received during the baseline period; and
apply the clustering algorithm to the input vector.

25. The server of claim 24, wherein the clustering algorithm is based at least in part upon adaptive resonance theory.

26. The server of claim 20, wherein the processor is further operable to determine system characteristics during the baseline period by:
determining processor load during the baseline period;
determining memory usage during the baseline period; and
determining processing time during the baseline period.

27. The server of claim 19, wherein the processor operable to deny traffic from the endpoint comprises the processor operable to deny traffic from an IP address associated with the endpoint.

28. The method of claim 12, wherein determining the baseline error comprises determining a delay period associated with the baseline error message.

29. The server of claim 21, wherein the processor operable to determine the baseline error message comprises the processor operable to determine a delay period associated with the baseline error message.
